(19) United States
(12) Patent Application Publication
(10) Pub. No.: US 2015/0214684 A1
(43) Pub. Date: Jul. 30, 2015

(54) USB ADAPTER MODULE

(71) Applicant: Ting-Chi CHEN, New Taipei City (TW)

(72) Inventors: Ting-Chi CHEN, New Taipei City (TW); Te-Fu LU, New Taipei City (TW); Su-Yung CHOU, New Taipei City (TW); Yi-Chieh LIN, New Taipei City (TW)

(73) Assignee: Ting-Chi CHEN, New Taipei City (TW)

(21) Appl. No.: 14/168,394

(22) Filed: Jan. 30, 2014

(51) Int. Cl. H01R 29/00; H01R 35/04

(52) U.S. Cl. CPC H01R 29/00; H01R 35/04

(57) ABSTRACT

A USB adapter module includes an electrical insulating terminal holder having a front tongue plate forwardly extended from a front side of a holder body thereof, an EMI shielding shell surrounding the electrical insulating terminal holder, a conducting terminal set including conducting terminals and signal terminals respectively mounted in the electrical insulating terminal holder, and a swivel adapter pivotally connected to the EMI shielding shell and turnable between a horizontal close position for micro USB application and a vertical open position for allowing the assembly of the electrical insulating terminal holder, conducting terminals, signal terminals and EMI shielding shell to be used as an independent USB3.0/2.0 connector without causing interference.

### BACKGROUND OF THE INVENTION

1. Field of the Invention

The present invention relates to electrical connectors, and more particularly to a USB adapter module, which comprises an electrical insulating terminal holder having a front tongue plate forwardly extended from a front side of a holder body thereof, an EMI shielding shell surrounding the electrical insulating terminal holder, a conducting terminal set mounted in the electrical insulating terminal holder and a swivel adapter pivotally connected to the EMI shielding shell and, which provides a wide range of applications and assures a high level of application safety.

2. Description of the Related Art

Following fast development of computer electronic technology, many high mobility electrical and electronic apparatus are well developed and widely used by people for different applications, bringing convenience to people and making people's life more comfortable. Further, high-speed, high-power and sophisticated mobile electrical and electronic devices and related products with large capacity and low profile characteristics have been continuously created. Further, many different transmission interfaces and connectors are widely used in electrical and electronic products for power and data transmission. For connecting different component parts, different transmission interfaces or connectors of different sizes and configurations must be used. Therefore, an electrical or electronic device needs to provide sufficient installation space for the installation of different types of transmission interfaces and connectors.

Further, it is the market trend to create mobility electronic apparatuses having light, thin, short and small characteristics. In consequence, circuit board electronic components must be made extremely strong, small and precise. Further, many different male and female electrical connectors are used in an electronic apparatus to connect different components and parts to a circuit board for the connection of mating electronic cards and/or connectors. These electrical connectors occupy much circuit layout space of the circuit board and the inside space of the electronic apparatus. It is quite important to fully utilize the circuit layout space of a circuit board and the internal space of an electronic apparatus.

The inventor of the present invention filed a Taiwan patent application, entitled “USB adapter module”, on Jun. 11, 2013, under Application Number 10212077. According to this design, as shown in FIG. 11, the USB adapter module A comprises an electrical insulating terminal holder B having a front extension B1, an EMI (electromagnetic interference) shielding shell C surrounding the electrical insulating terminal holder B, a sub shielding shell C1 forwardly extended from the EMI shielding shell C and surrounding the front extension B1, and conducting terminals mounted in the electrical insulating terminal holder B and the front extension B1. When connecting this design of USB adapter module A to an external mating connector D, the power terminals of the external mating connector D will touch the surface of the sub shielding shell C1 and then electrically contact the power terminals B2 in the electrical insulating terminal holder B. A transient high current (or high voltage) will be produced during transmission of power supply through the power terminals of the external mating connector D and the power terminals B2 in the electrical insulating terminal holder B, affecting signal transmission stability. A short circuit may occur when a transient high current (or high voltage) is produced during power transmission.

Therefore, there is room for improvement on the aforesaid prior art design.

### SUMMARY OF THE INVENTION

The present invention has been accomplished under the circumstances in view. It is one object of the present invention to provide a USB adapter module, which provides a wide range of applications and assures a high level of application safety.

To achieve this and other objects of the present invention, a USB adapter module in accordance with one embodiment of the present invention comprises an electrical insulating terminal holder, a conducting terminal set including conducting terminals and signal terminals, an EMI (electromagnetic interference) shielding shell surrounding the electrical insulating terminal holder, and a swivel adapter pivotally connected to the EMI shielding shell. The holder body of the electrical insulating terminal holder, the conducting terminals and signal terminals of the conducting terminal set and the EMI shielding shell are configured to constitute a USB (USB3.0 or 2.0) connector. Further, the swivel adapter is pivotally connected to a mounting structure of the EMI shielding shell. When the swivel adapter is closed on the mounting structure of the EMI shielding shell, the insulative terminal holder and metal shielding cover of the swivel adapter cover the top side of a front tongue plate of the electrical insulating terminal holder, and rear abutment portions of the adapter terminals are respectively electrically abutted against mating contact end pieces of the respective signal terminals for micro USB application. When the swivel adapter is lifted from the EMI shielding shell, the rear abutment portions of the adapter terminals are kept away from the mating contact end pieces of the respective signal terminals, preventing interference with the application of the USB (USB3.0 or 2.0) connector.

Further, the conducting terminal set comprises 5pcs of conducting terminals, and 4pcs of signal terminals. The 5pcs of conducting terminals are classified as 1^{st} grounding terminal, 1^{st} differential signal terminal, 2^{nd} differential signal terminal, 3^{rd} differential signal terminal and 4^{th} differential signal terminal. The 1^{st} grounding terminal is arranged on the middle. The 1^{st} differential signal terminal and the 4^{t1} differential signal terminal are arranged in parallel at two opposite lateral sides relative to the 1^{st} grounding terminal. The 2^{nd} differential signal terminal and the 3^{rd} differential signal terminal are arranged in parallel and respectively spaced between the 1^{st} grounding terminal and the 1^{st} differential signal terminal and between the 1^{st} grounding terminal and the 4^{th} differential signal terminal. The signal terminals are classified as 5^{th} differential signal terminal, 6^{th} differential signal terminal, 1^{St} power terminal and 2^{nd} grounding terminal. The 5^{th} differential signal terminal and the 6^{th} differential signal terminal are arranged in parallel between the 1^{st} grounding terminal and the 2^{nd} differential signal terminal and between the 1^{st} grounding terminal and the 3^{rd} differential signal terminal. The 1^{st} power terminal and the 2^{nd} grounding terminal are arranged in parallel at two opposite lateral sides relative to the conducting terminals. Further, the holder body of the electrical insulating terminal holder matched, the conducting terminals, the signal terminals and the EMI shielding shell constitute a USB3.0 or 2.0 connector.

Further, the adapter terminals of the swivel adapter each have a rear part thereof curved sideways to form an extension arm that has the distal end thereof forming a rear abutment portion of the respective adapter terminal. Further, the number of the adapter terminals of the swivel adapter is five. These 5pcs of adapter terminals are classified as the 7^{th} differential signal terminal, the 8^{th} differential signal terminal, the 2^{nd} power terminal, the 3^{rd} grounding terminal and the supplementary transmission terminal. The 7^{th} differential signal terminal and the 8^{th} differential signal terminal are arranged in parallel on the middle. The 2^{nd} power terminals and the 3^{rd} grounding terminal are arranged in parallel at two opposite lateral sides relative to the 7^{th} differential signal terminal and the 8^{th} differential signal terminal. The supplementary transmission terminal is connected to an inner side of the 3^{rd} grounding terminal. Further, the front contact portion of the 2^{nd} power terminals has a relatively larger width to increase its current loading capacity. Further, the front contact portion of the 2^{nd} power terminals is made in the shape of an open loop, providing two contact surfaces. Further, a first supplementary rib and a second supplementary rib are respectively outwardly extended from the extension arms of the 2^{nd} power terminals and 3^{rd} grounding terminal, each having a protruded retaining portion. Thus, the adapter terminals, the first supplementary rib and the second supplementary rib are arranged to fit USB/OTG specifications. Thus, the front contact portions of the adapter terminals, the tongue plate portion of the insulative terminal holder and the front extension casing of the metal shielding cover constitute a micro USB connector.

The USB adapter module further comprises a pivot connection structure for pivotally coupling the metal shielding cover of the swivel adapter and the mounting structure of the EMI shielding shell together. The pivot connection structure comprises two pivot rods bilaterally located at the metal shielding cover or mounting structure, at least one retaining hole located at the metal shielding cover or mounting structure, two pivot holes bilaterally located at the mounting structure or metal shielding cover and respectively pivotally coupled to the pivot rods, and at least one retaining rod located at the mounting structure or metal shielding cover and detachably engageable with the at least one retaining hole.

### BRIEF DESCRIPTION OF THE DRAWINGS

FIG. 1 is an oblique top elevation of a USB adapter module in accordance with a first embodiment of the present invention.

FIG. 2 is an exploded view of the USB adapter module in accordance with the first embodiment of the present invention.

FIG. 3 corresponds to FIG. 2 when viewed from another angle.

FIG. 4 is a sectional side view of the USB adapter module in accordance with the first embodiment of the present invention.

FIG. 5 is a schematic oblique top elevation, illustrating the arrangement of the conducting terminals and signal terminals of the conducting terminal set of the USB adapter module in accordance with the first embodiment of the present invention.

FIG. 6 is a schematic top view of the USB adapter module in accordance with the first embodiment of the present invention.

FIG. 7 is a schematic front view of the USB adapter module in accordance with the first embodiment of the present invention.

FIG. 8 is a schematic side plain view of the USB adapter module in accordance with the first embodiment of the present invention, illustrating the swivel adapter in the vertical open position.

FIG. 9 is a schematic sectional side view of the USB adapter module in accordance with the first embodiment of the present invention, illustrating the swivel adapter in the vertical open position.

FIG. 10 is an exploded view of a USB adapter module in accordance with a second embodiment of the present invention.

FIG. 11 is an exploded view of a USB connector according to the prior art.

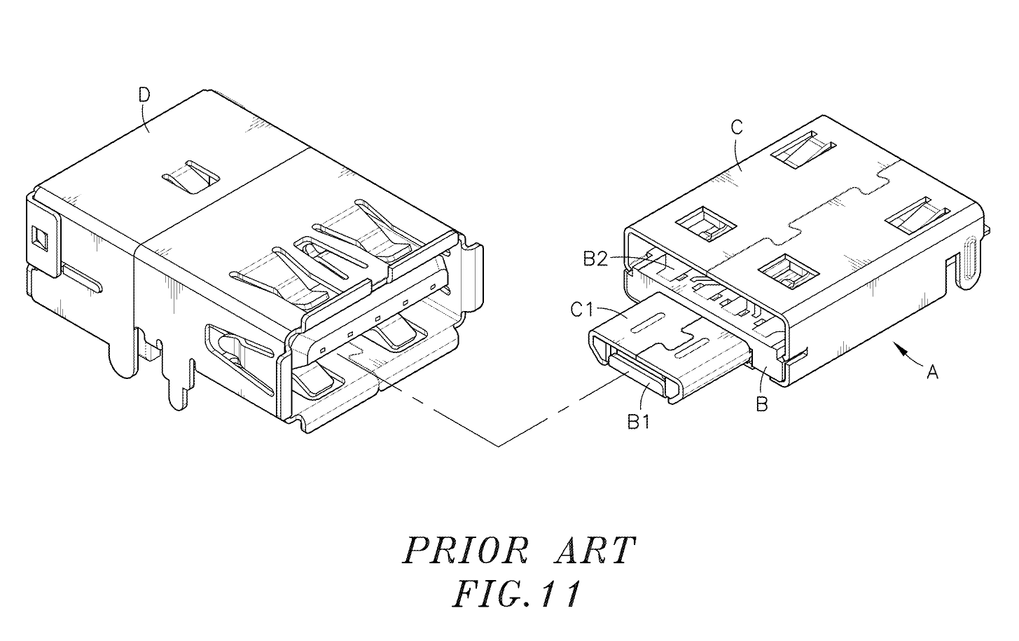

### DETAILED DESCRIPTION OF THE PREFERRED EMBODIMENT

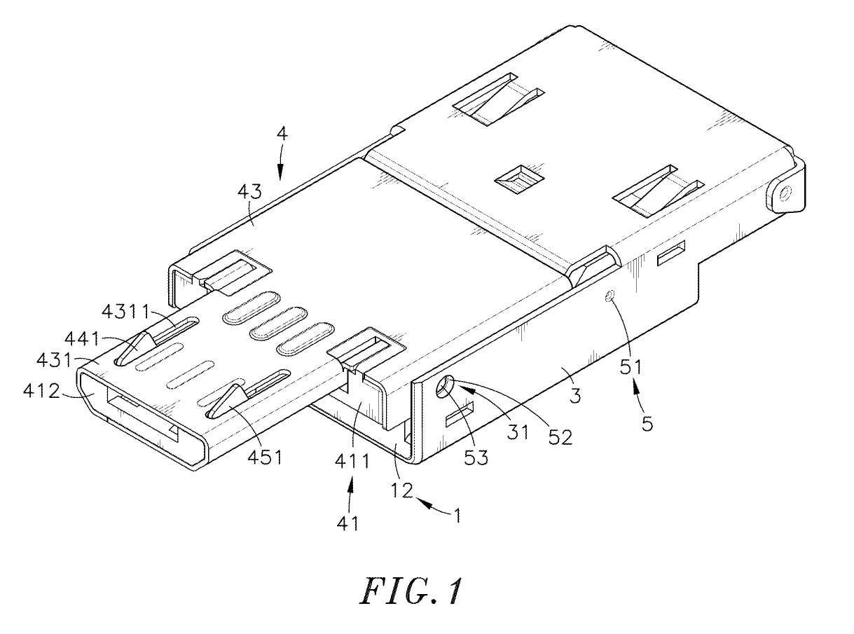

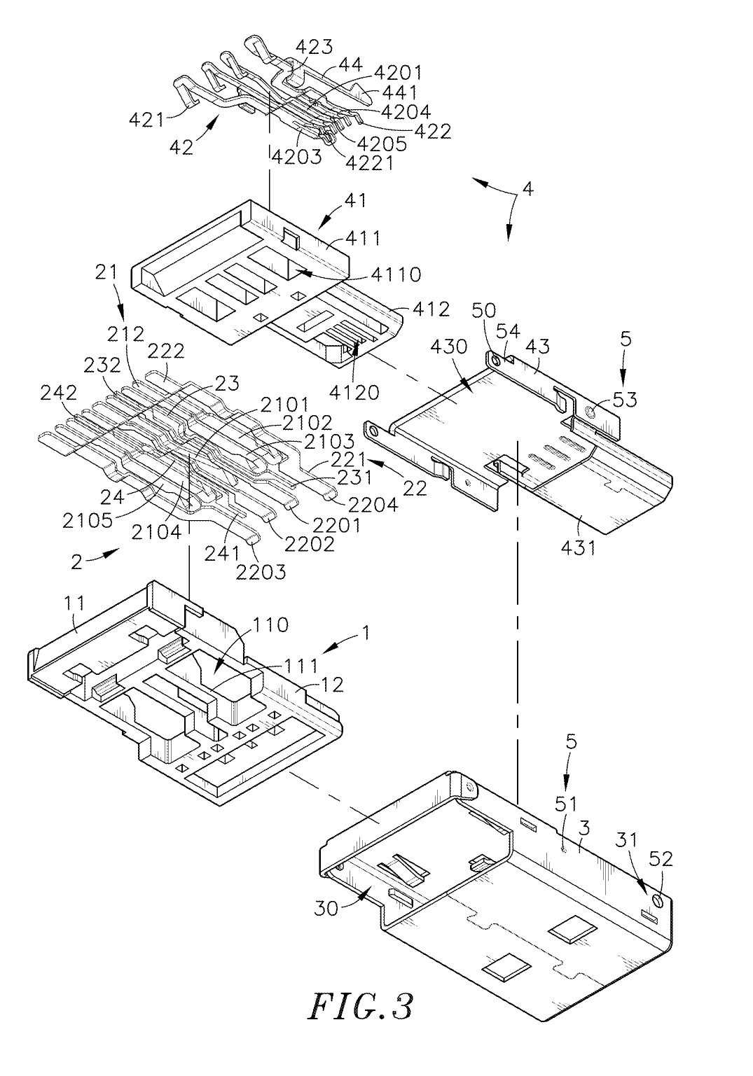

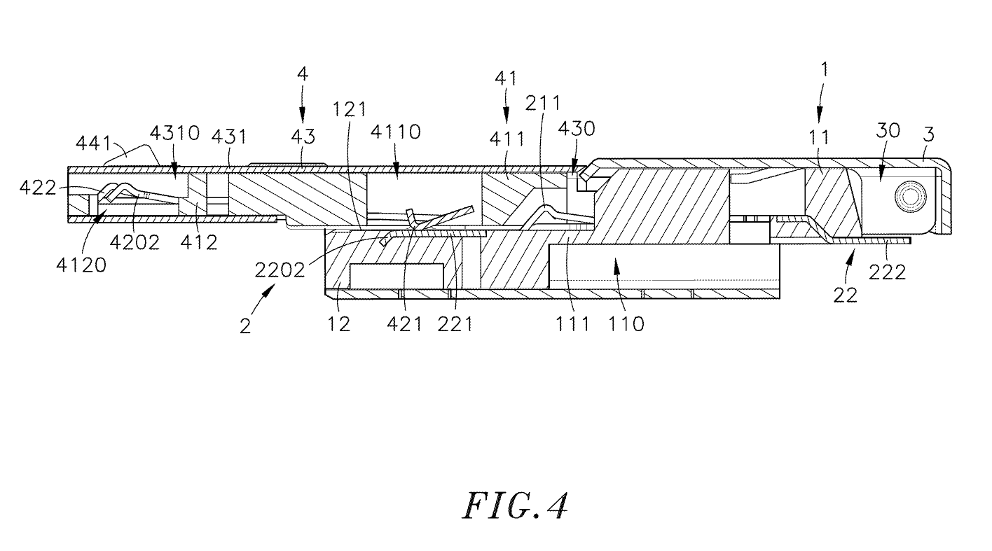

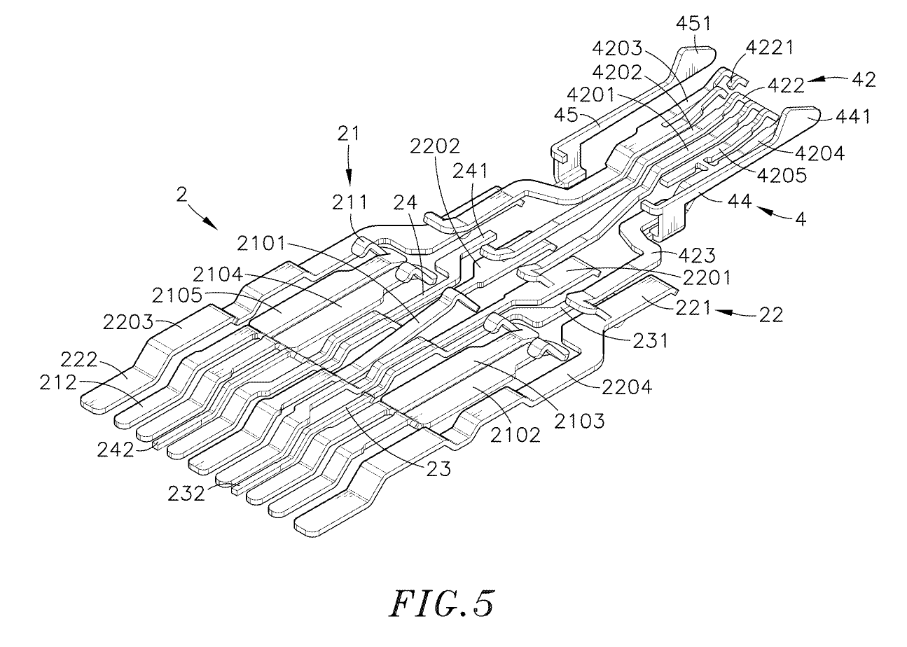

Referring to FIGS. 1-5, a USB adapter module in accordance with a first embodiment of the present invention is shown. As illustrated, the USB adapter module comprises an electrical insulating terminal holder 1, a conducting terminal set 2, an EMI (electromagnetic interference) shielding shell 3, and a swivel adapter 4.

The electrical insulating terminal holder 1 comprises a holder body 11, a plurality of partition ribs 111 and elongated openings 110 alternatively disposed in a middle part of the holder body 11, a front tongue plate 12 of relatively thinner thickness forwardly extended from a front side of the holder body 11, and a bearing surface portion 121 defined at a top side of the front tongue plate 12.

The conducting terminal set 2 comprises a plurality of conducting terminals 21, a plurality of signal terminals 22. Each conducting terminal 21 comprises a mating contact end portion 211 located at a front end thereof, and a bonding end portion 212 located at an opposite rear end thereof. Each signal terminal 22 comprises a mating contact end piece 221 located at a front end thereof, and a bonding end piece 222 located at an opposite rear end thereof.

The EMI shielding shell 3 comprises an accommodation chamber 30 and a mounting structure 31.

The swivel adapter 4 comprises an insulative terminal holder 41, a set of adapter terminals 42, and a metal shielding cover 43. The insulative terminal holder 41 comprises a base portion 411, a plurality of terminal slots 4110 cut through opposing top and bottom sides of the base portion 411 and arranged in parallel, a tongue plate portion 412 of relatively shorter width and height forwardly extended from a front side of the base portion 411, and a plurality of terminal grooves 4120 defined in a top side of the tongue plate portion 412. The adapter terminals 42 are mounted in the base portion 411 and tongue plate portion 412 of the insulative terminal holder 41, each having a rear abutment portion 421 inserted through and suspending in a bottom side of one respective terminal slot 4110, and an opposite front contact portion 422 positioning in one respective terminal groove 4120 in the tongue plate portion 412. The metal shielding cover 43 comprises a bottom-open receiving chamber 430 adapted for receiving the base portion 411 of the insulative terminal holder 41, a front extension casing 431 located at a front side relative to the bottom-open receiving chamber 430, a sub receiving chamber 4310 defined in the front extension casing 431 in communication with the bottom-open receiving chamber 430 for receiving the tongue plate portion 412 of the insulative terminal holder 41 and the adapter terminals 42, and two longitudinal slots 4311 cut through the top wall of the front extension casing 431 in communication with the sub receiving chamber 4310.

When assembling the USB adapter module, mount the conducting terminals 21 and the signal terminals 22 in the electrical insulating terminal holder 1 in such a manner that the mating contact end portions 211 of the conducting terminals 21 are respectively suspended in the elongated openings 110 within the holder body 11, and the bonding end portions 212 of the conducting terminals 21 are respectively extended out of an opposing rear side of the holder body 11; the signal terminals 22 are respectively mounted in the partition ribs 111 with the mating contact end pieces 221 respectively extended to the bearing surface portion 121 at the top side of the front tongue plate 12 and the bonding end pieces 222 respectively extended out of the rear side of the holder body 11 in co-planar relationship to the bonding end portions 212 of the conducting terminals 21. Thereafter, attach the EMI shielding shell 3 to the electrical insulating terminal holder 1 to have the holder body 11 of the electrical insulating terminal holder 1 be accommodated in the accommodation chamber 30 and the front tongue plate 121 of the electrical insulating terminal holder 1 be exposed to the outside of the front tongue plate 121 of the electrical insulating terminal holder 1, and then pivotally connect the swivel adapter 4 to the mounting structure 31 of the EMI shielding shell 3, enabling the swivel adapter 4 to be biased relative to the EMI shielding shell 3 and the electrical insulating terminal holder 1 through 90° angle between a horizontal close position where the base portion 411 of the insulative terminal holder 41 is superimposed on the front tongue plate 121 of the electrical insulating terminal holder 1 and the rear abutment portions 421 of the adapter terminals 42 are kept in positive contact with the mating contact end pieces 221 of the respective signal terminals 22, and a vertical open position where the rear abutment portions 421 of the adapter terminals 42 are kept apart from the mating contact end pieces 221 of the respective signal terminals 22. Thus, the electrical insulating terminal holder 1, the conducting terminal set 2, the EMI shielding shell 3 and the swivel adapter 4 are assembled together, forming a USB adapter module.

Further, the metal shielding cover 43 of the swivel adapter 4 and the mounting structure 31 of the EMI shielding shell 3 are pivotally connected together by means of a pivot connection structure 5. The pivot connection structure 5 comprises two pivot rods 51 (or pivot holes 50) respectively located at two opposite upright lateral walls of the mounting structure 31 of the EMI shielding shell 3, at least one retaining hole 52 (or retaining rod 53) located at the mounting structure 31 at a front side relative to the pivot rods 51 (or pivot holes 50), two extension arms 54 respectively backwardly extended from two opposite sidewalls of the metal shielding cover 43, two pivot holes 50 (or pivot rods 51) respectively located at the extension arms 54 and respectively pivotally coupled to the pivot rods 51 (or pivot holes 50), and at least one retaining rod 53 (or retaining hole 52) located at the metal shielding cover 43 at a front side relative to the pivot holes 50 (or pivot rods 51) and detachably engageable with the at least one retaining hole 52 (or retaining rod 53) at the mounting structure 31. Thus, the metal shielding cover 43 of the swivel adapter 4 can be biased relative to the mounting structure 31 of the EMI shielding shell 3 between the aforesaid vertical open position and horizontal close position. When the metal shielding cover 43 of the swivel adapter 4 is closed on the EMI shielding shell 3, the at least one retaining hole 52 (or retaining rod 53) is respectively forced into engagement with the at least one retaining rod 53 (or retaining hole 52), and the base portion 411 of the insulative terminal holder 41 is superimposed on the front tongue plate 121 of the electrical insulating terminal holder 1, and the rear abutment portions 421 of the adapter terminals 42 are kept in positive contact with the mating contact end pieces 221 of the respective signal terminals 22, forming a micro USB connector.

Further, the number of the conducting terminals 21 of the conducting terminal set 2 is five, i.e., the 1^{st} grounding terminal 2101, the 1^{st} differential signal terminal 2102, the 2^{nd} differential signal terminal 2103, the 3^{rd} differential signal terminal 2104 and the 4^{th} differential signal terminal 2105, wherein the 1^{st} grounding terminal 2101 is arranged on the middle, the 1^{st} differential signal terminal 2102 and the 4^{th} differential signal terminal 2105 are arranged in parallel at two opposite lateral sides relative to the 1^{st} grounding terminal 2101, and the 2^{nd} differential signal terminal 2103 and the 3^{rd} differential signal terminal 2104 are arranged in parallel and respectively spaced between the 1^{st} grounding terminal 2101 and the 1^{st} differential signal terminal 2102 and between the 1^{st} grounding terminal 2101 and the 4^{th} differential signal terminal 2105. The number of the transmission terminals 22 is four, i.e., the 5^{th} differential signal terminal 2201, the 6^{th} differential signal terminal 2202, the 1^{St} power terminal 2203 and the 2^{nd} grounding terminal 2204, wherein the 5^{th} differential signal terminal 2201 and the 6^{th} differential signal terminal 2202 are arranged in parallel between the 1^{St} grounding terminal 2101 and the 2^{nd} differential signal terminal 2103 and between the 1^{st} grounding terminal 2101 and the 3^{rd} differential signal terminal 2104; the 1^{st} power terminal 2203 and the 2^{nd} grounding terminal 2204 are arranged in parallel at two opposite lateral sides relative to the conducting terminals 21. Thus, the conducting terminals 21, the transmission terminals 22 and the EMI shielding shell 3 constitute a USB3.0 or 2.0 connector.

The adapter terminals 42 of the swivel adapter 4 each have a rear part thereof curved sideways to form an extension arm 423 that has the distal end thereof forming the rear abutment portion 421 of the respective adapter terminal 42. The extension arms 423 of the adapter terminals 42 are distributed in a sector-like configuration. Further, the number of the adapter terminals 42 of the swivel adapter 4 is five. These 5pcs of adapter terminals 42 are classified as the 7^{th} differential signal terminal 4201, the 8^{th} differential signal terminal 4202, the 2^{nd} power terminal 4203, the 3^{rd} grounding terminal 4204 and the supplementary transmission terminal 4205, wherein the 7^{th} differential signal terminal 4201 and the 8^{th} differential signal terminal 4202 are arranged in parallel on the middle; the 2^{nd} power terminals 4203 and the 3^{rd} grounding terminal 4204 are arranged in parallel at two opposite lateral sides relative to the 7^{th} differential signal terminal 4201 and the 8^{th} differential signal terminal 4202. The supplementary transmission terminal 4205 is connected to an inner side of the 3^{rd} grounding terminal 4204. Further, the front contact portion 422 of the 2^{nd} power terminals 4203 has a relatively larger width to increase its current loading capacity; the front contact portion 422 of the 2^{nd} power terminals 4203 is made in the shape of an open loop, providing two contact surfaces 4221. Further, a first supplementary rib 44 and a second supplementary rib 45 are respectively outwardly extended from the extension arms 423 of the 3^{rd} grounding terminal 4204 and 2^{nd} power terminals 4203, each having a protruded retaining portion 441 or 451. Thus, the adapter terminals 42, the first supplementary rib 44 and the second supplementary rib 45 are arranged to fit USB/OTG specifications. Further, the protruded retaining portions 441 and 451 of the 3^{rd} grounding terminal 4204 and 2^{nd} power terminals 4203 are respectively inserted through the longitudinal slots 4311 of the front extension casing 431 of the metal shielding cover 43 to the outside of the metal shielding cover 43, enabling the adapter terminals 42 and the front extension casing 431 of the metal shielding cover 43 to constitute a micro USB connector and enhancing the EMI protection ability of the USB adapter module against high instantaneous current and voltage.

The conducting terminal set 2 further comprises a first isolation terminal 23 spaced between the 2^{nd} differential signal terminal 2103 and the 5^{th} differential signal terminal 2201, and a second isolation terminal 24 spaced between the 3^{rd} differential signal terminal 2104 and the 6^{th} differential signal terminal 2202. The first isolation terminal 23 has a first isolation terminal portion 231 located at one end thereof and extended to the space between the 5^{th} differential signal terminal 2201 and the 2^{nd} grounding terminal 2204, and a bonding end portion 232 located at an opposite end thereof. The second isolation terminal 24 has a second isolation terminal portion 241 located at one end thereof and extended to the space between the 6^{th} differential signal terminal 2202 and the 1^{st} power terminal 2203, and a bonding end portion 242 located at an opposite end thereof. The first isolation terminal 23 and the second isolation terminal 24 respectively isolate the 5^{th} differential signal terminal 2201, the 6^{th} differential signal terminal 2202, the 1^{st} power terminal 2203 and the 2^{nd} grounding terminal 2204, and thus signal transmission through the 5^{th} differential signal terminal 2201 and the 6^{th} differential signal terminal 2202 is prohibited from interference of the noises or magnetic waves produced by the adjacent power or grounding signals.

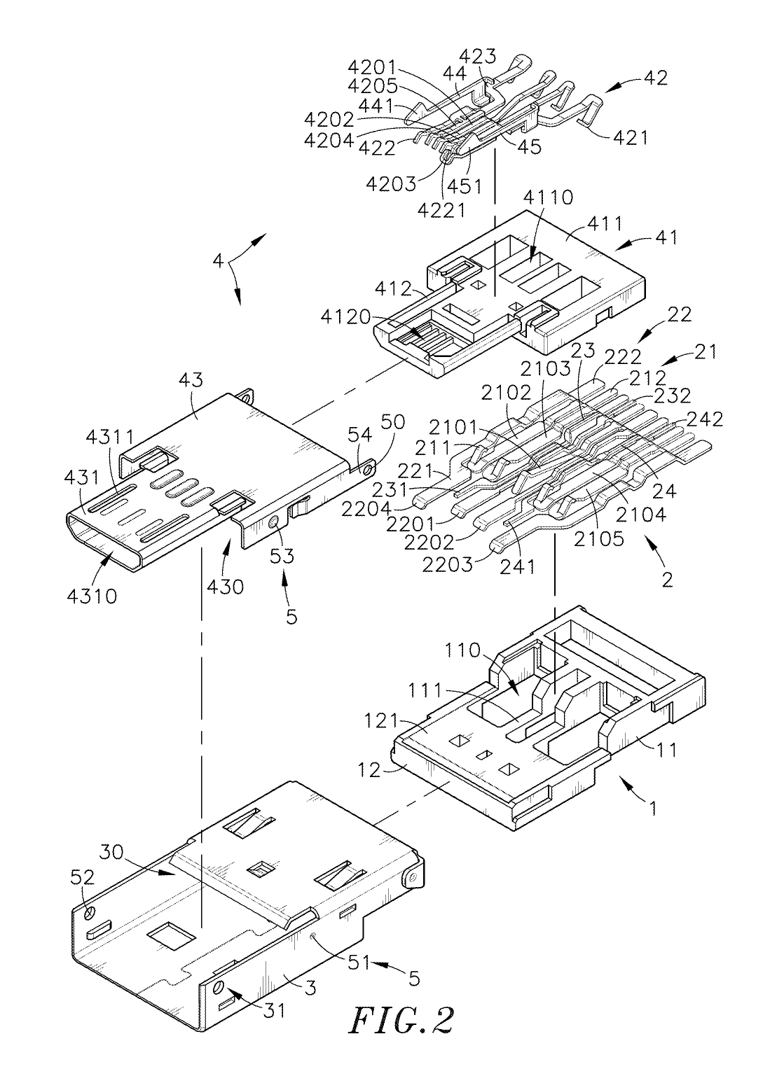

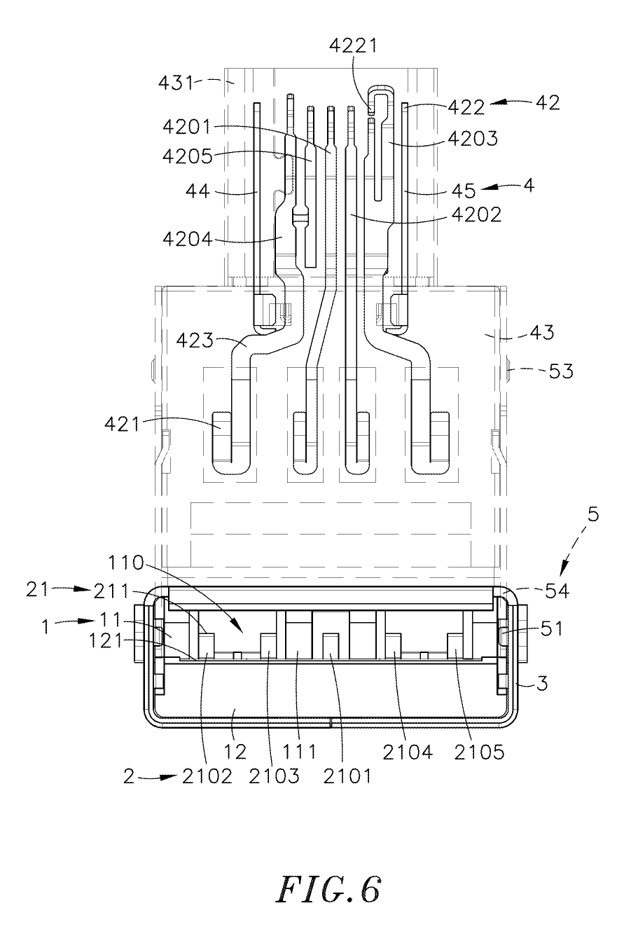

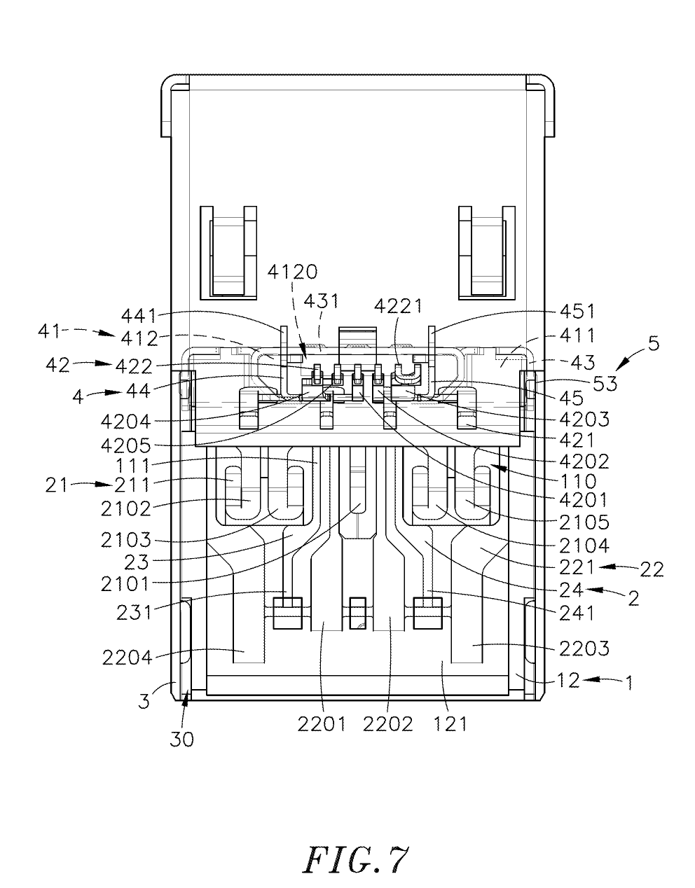

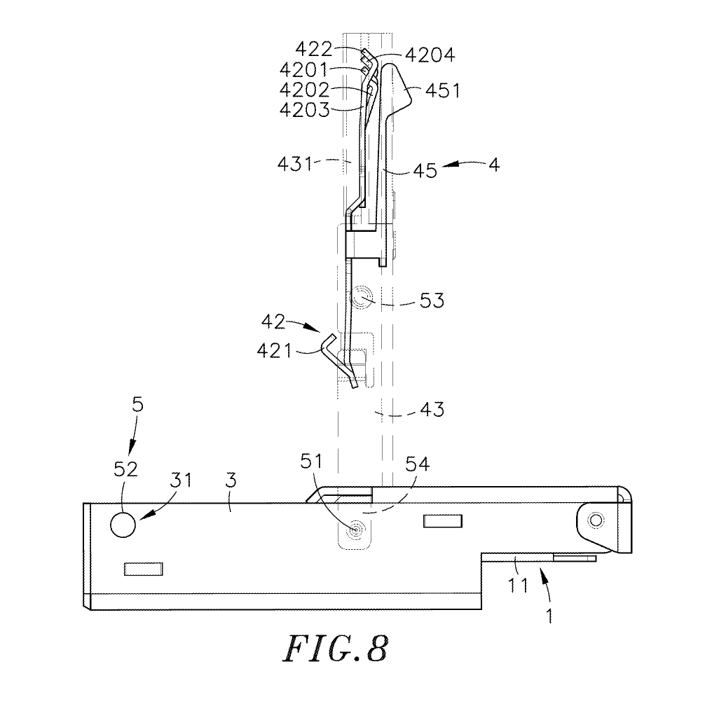

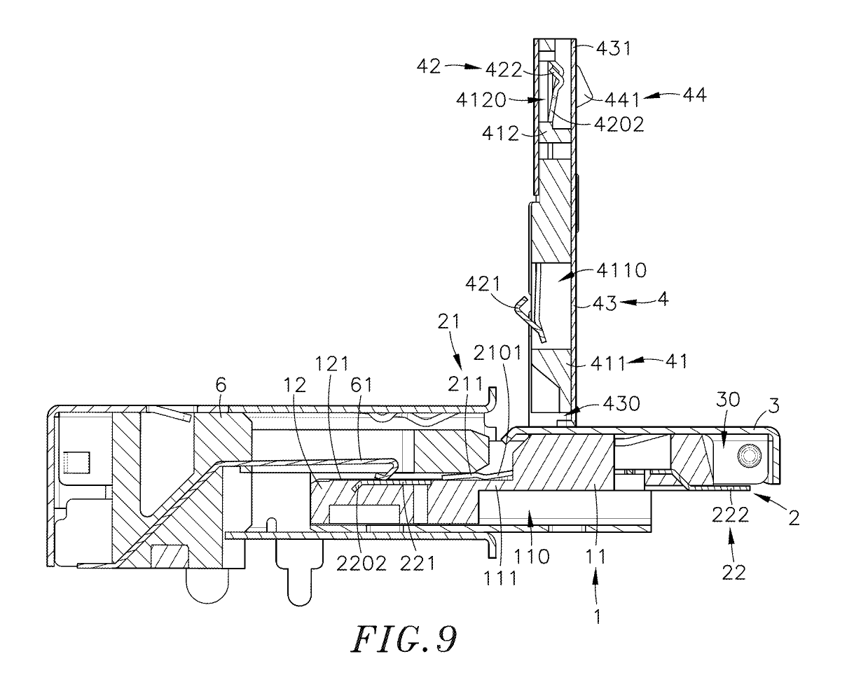

Referring to FIGS. 6-9 and FIGS. 2, 4 and 5 again, the EMI shielding shell 3 surrounds the electrical insulating terminal holder 1 and the conducting terminal set 2, and the holder body 11 of the electrical insulating terminal holder 1 matches with the conducting terminals 21 and signal terminals 22 of the conducting terminal set 2 and the EMI shielding shell 3 to constitute a USB (USB3.0 or 2.0) connector. Further, the swivel adapter 4 is pivotally connected to the mounting structure 31 of the EMI shielding shell 3. When the swivel adapter 4 is closed on the mounting structure 31 of the EMI shielding shell 3, the insulative terminal holder 41 and the metal shielding cover 43 of the swivel adapter 4 cover the top side of the mounting structure 31 of the EMI shielding shell 3, and the rear abutment portions 421 of the adapter terminals 42 are respectively electrically abutted against the mating contact end pieces 221 of the respective signal terminals 22, and thus, the front contact portions 422 of the adapter terminals 42, the tongue plate portion 412 of the insulative terminal holder 41 and the front extension casing 431 of the metal shielding cover 43 constitute a micro USB connector that can be electrically connected to an external mating electrical connector 6 without causing contact between the power terminals 61 of the external mating electrical connector 6 and the mating contact end pieces 221 of the signal terminals 2, assuring a high level of application safety. At this time, the rear abutment portions 421 of the adapter terminals 42 are respectively electrically abutted against the mating contact end pieces 221 of the respective signal terminals 22 for signal and power transmission.

After the swivel adapter 4 is turned relative to the mounting structure 31 of the EMI shielding shell 3 from the horizontal close position to the vertical open position, the swivel adapter 4 is disposed perpendicular to the electrical insulating terminal holder 1 and the EMI shielding shell 3. At this time, the front tongue plate 12 of the holder body 11 of the electrical insulating terminal holder 1 matches the EMI shielding shell 3 to constitute a USB (USB3.0 or 2.0) connector for connection to an external mating USB connector, and the mating contact end pieces 221 of the signal terminals 2 are kept away from the mating contact end pieces 221 of the respective signal terminals 22 without interfering with the performance of the USB (USB3.0 or 2.0) connector.

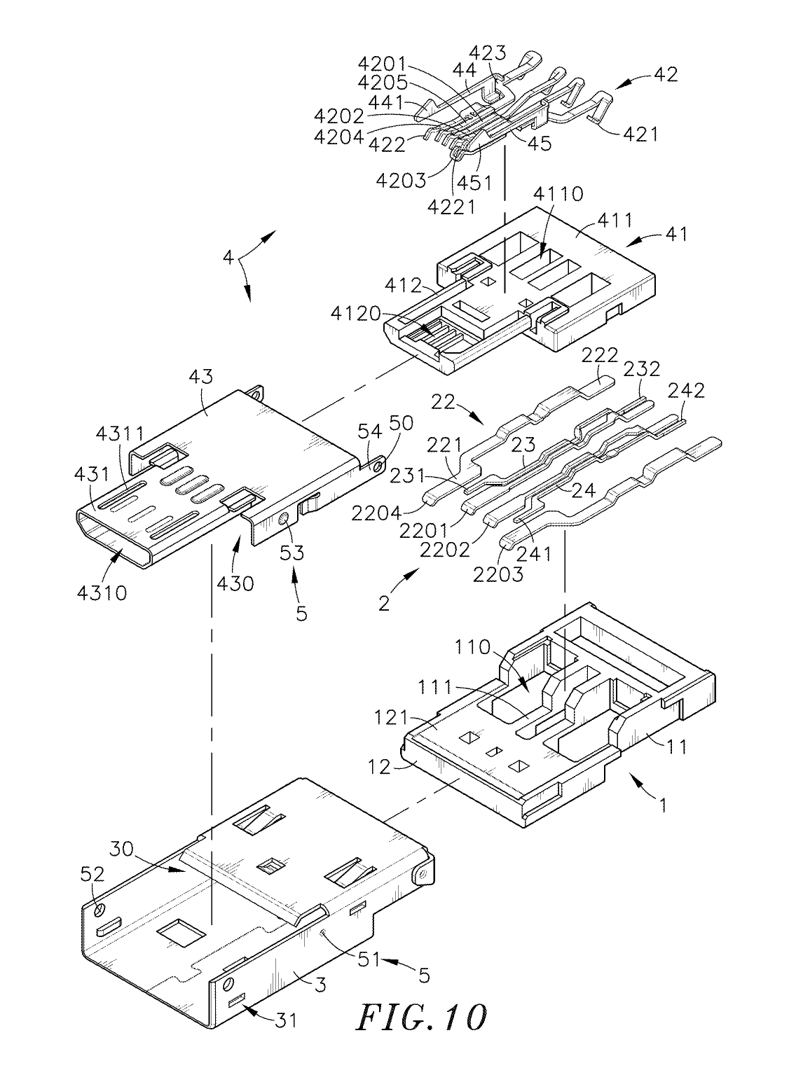

Referring to FIG. 10, a USB adapter module in accordance with a second embodiment of the present invention is shown. This second embodiment is substantially similar to the aforesaid first embodiment with the exception of the arrangement of the conducting terminal set 2. According to this embodiment, the signal terminals 22 of the conducting terminal set 2 are respectively mounted in the partition ribs 111 of the holder body 11 with the mating contact end pieces 221 respectively extended to the bearing surface portion 121 of the front tongue plate 12 and exposed to the outside of the mounting structure 31 of the EMI shielding shell 3 and the bonding end pieces 222 respectively extended out of the rear side of the holder body 11 of the electrical insulating terminal holder 1; the swivel adapter 4 is pivotally connected to the mounting structure 31 of the EMI shielding shell 3, enabling the rear abutment portions 421 of the adapter terminals 42 to be respectively electrically abutted against the mating contact end pieces 221 of the respective signal terminals 22 for signal and power transmission. Thus, the adapter terminals 42 matches the insulative terminal holder 41 and metal shielding cover 43 of the swivel adapter 4 to constitute a micro USB connector that is supported on the front tongue plate 12 of the electrical insulating terminal holder 1 and exposed to the outside of the mounting structure 31 of the EMI shielding shell 3 for connection with an external mating micro USB connector without causing interference.

Further, when the swivel adapter 4 is biased relative to the EMI shielding shell 3 and the electrical insulating terminal holder 1 from the horizontal close position to the vertical open position, the mating contact end pieces 221 of the respective signal terminals 22 match the EMI shielding shell 3 to constitute a USB (USB2.0) connector that can be electrically connected to an external mating USB (USB2.0) connector without interference, assuring a high level of application safety. Thus, the USB adapter module provides a wide range of applications.

In conclusion, the invention provides a USB adapter module, which comprises an electrical insulating terminal holder 1 comprising a holder body 11 defining a plurality of alternatively arranged elongated openings 110 and partition ribs 111 and a front tongue plate 12 defining a bearing surface portion 121, a conducting terminal set 2 comprising a plurality of conducting terminals 21 and a plurality of signal terminals 22 respectively mounted in the holder body 11 and front tongue plate 12 of the electrical insulating terminal holder 1, an EMI (electromagnetic interference) shielding shell 3 surrounding the electrical insulating terminal holder 1 and matching with the conducting terminals 21 and signal terminals 22 of the conducting terminal set 2 and the electrical insulating terminal holder 1 to constitute a USB (USB3.0 or 2.0) connector, and a swivel adapter 4 comprising an insulative terminal holder 41, a set of adapter terminals 42 mounted in the insulative terminal holder 41 with respective rear abutment portions 421 thereof detachably abutted against the mating contact end pieces 221 of the respective signal terminals 22 for signal and power transmission and a metal shielding cover 43 surrounds the insulative terminal holder 41 and pivotally connected to a mounting structure 31 of the EMI shielding shell 3 for enabling the swivel adapter 4 to be used as a micro USB connector. Thus, the USB adapter module has a wide range of applications and assures a high level of application safety.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A USB adapter module, comprising:
an electrical insulating terminal holder comprising a holder body, a plurality of elongated openings cut through opposing top and bottom walls of said holder body, a front tongue plate forwardly extended from a front side of said holder body, and a bearing surface portion defined at a top side of said front tongue plate;
a conducting terminal set comprising a plurality of conducting terminals mounted in said holder body of said electrical insulating terminal holder, a plurality of signal terminals mounted in said holder body and extended to said front tongue plate, each said conducting terminal comprising a mating contact end portion located at a front end thereof and suspending in one said elongated opening of said electrically insulating terminal holder and a bonding end portion located at an opposite rear end thereof and extended out of a rear side of said holder body of said electrically insulative terminal holder, each said signal terminal comprising a mating contact end piece located at a front end thereof and supported on the bearing surface portion at the top side of said front tongue plate and a bonding end piece located at an opposite rear end thereof and extended out of a rear side of said holder body of said electrically insulative terminal holder in co-planar relationship to the bonding end portions of said conducting terminals;
an EMI shielding shell surrounding said electrically insulative terminal holder, said EMI shielding shell comprising an accommodation chamber that accommodates said holder body and a mounting structure that surrounds a part of said front tongue plate; and
a swivel adapter comprising a metal shielding cover pivotally connected to said mounting structure of said EMI shielding shell, an insulative terminal holder mounted in said metal shielding cover and a set of adapter terminals mounted in said insulative terminal holder, said insulative terminal holder comprising a base portion, a plurality of terminal slots cut through opposing top and bottom sides of said base portion and arranged in parallel and a tongue plate portion forwardly extended from a front side of said base portion, said metal shielding cover comprising a bottom-open receiving chamber adapted for receiving the base portion of said insulative terminal holder, a front extension casing located at a front side relative to said bottom-open receiving chamber, a sub receiving chamber defined in said front extension casing in communication with said bottom-open receiving chamber and adapted for receiving said tongue plate portion of said insulative terminal holder and said adapter terminals and two longitudinal slots cut through a top wall of said front extension casing in communication with said sub receiving chamber, said adapter terminals being mounted in said base portion and said tongue plate portion of said insulative terminal holder, each said adapter terminal comprising a rear abutment portion inserted through and suspending in a bottom side of one respective said terminal slot and an opposite front contact portion positioning in said tongue plate portion.

2. The USB adapter module as claimed in claim 1, wherein said electrical insulating terminal holder further comprises a plurality of partition ribs defined in said holder body and respectively disposed between each two adjacent said elongated openings; said signal terminals of said conducting terminal set are respectively mounted in said partition ribs with the respective mating contact end pieces thereof supported on the bearing surface portion at the top side of said front tongue plate.

3. The USB adapter module as claimed in claim 1, wherein said insulative terminal holder of said swivel adapter further comprises a plurality of terminal grooves formed in a top wall of said tongue plate portion; the front contact portions of said adapter terminals are respectively positioned in said terminal grooves in said tongue plate portion.

4. The USB adapter module as claimed in claim 3, wherein said tongue plate portion of said insulative terminal holder of said swivel adapter has relatively shorter width and height than said insulative terminal holder; said insulative terminal holder of said swivel adapter further comprises a plurality of terminal grooves formed in a top wall of said tongue plate portion; said adapter terminals are respectively mounted in said base portion of said terminal holder with the respective front contact portions thereof respectively positioned in the respective said terminal grooves in said tongue plate portion and the respective rear abutment portions thereof downwardly extended out of said terminal slots for abutment against the mating contact end pieces of the respective said signal terminals

5. The USB adapter module as claimed in claim 1, wherein the number of said conducting terminals is five, and these 5pcs of conducting terminals are classified as 1^{st} grounding terminal, 1^{st} differential signal terminal, 2^{nd} differential signal terminal, 3^{rd} differential signal terminal and 4^{th} differential signal terminal, said 1^{st} grounding terminal being arranged on the middle, said 1^{st} differential signal terminal and said 4^{th} differential signal terminal being arranged in parallel at two opposite lateral sides relative to said 1^{st} grounding terminal, said 2^{nd} differential signal terminal and said 3^{rd} differential signal terminal being arranged in parallel and respectively spaced between said 1^{st} grounding terminal and said 1^{st} differential signal terminal and between said 1^{st} grounding terminal and 4^{th} differential signal terminal; the number of said signal terminals is four, and these signal terminals are classified as 5^{th} differential signal terminal, 6^{th} differential signal terminal, 1^{st} power terminal and 2^{nd} grounding terminal, said 5^{th} differential signal terminal and said 6^{th} differential signal terminal being arranged in parallel between said 1^{st} grounding terminal and said 2^{nd} differential signal terminal and between said 1^{st} grounding terminal and said 3^{rd} differential signal terminal, said 1^{st} power terminal and said 2^{nd} grounding terminal being arranged in parallel at two opposite lateral sides relative to said conducting terminals; said holder body of said electrical insulating terminal holder matches with said conducting terminals and said signal terminals and said EMI shielding shell to constitute a USB3.0 connector.

6. The USB adapter module as claimed in claim 5, wherein said conducting terminal set further comprises a first isolation terminal spaced between said 2^{nd} differential signal terminal and said 5^{th} differential signal terminal, and a second isolation terminal spaced between said 3^{rd} differential signal terminal and said 6^{th} differential signal terminal, said first isolation terminal having a first isolation terminal portion located at one end thereof and extended to the space between said 5^{th} differential signal terminal and said 2^{nd} grounding terminal and a bonding end portion located at an opposite end thereof, said second isolation terminal having a second isolation terminal portion located at one end thereof and extended to the space between said 6^{th} differential signal terminal and said 1^{st} power terminal and a bonding end portion located at an opposite end thereof said first isolation terminal and said second isolation terminal respectively isolating said 5^{th} differential signal terminal, said 6^{th} differential signal terminal, said 1^{st} power terminal and said 2^{nd} grounding terminal; the bonding end portions of said first isolation terminal and said second isolation terminal being disposed in co-planar relationship to the bonding end portions of said conducting terminals and the bonding end pieces of said signal terminals.

7. A USB adapter module, comprising:
an electrical insulating terminal holder comprising a holder body, a plurality of elongated openings cut through opposing top and bottom walls of said holder body, a front tongue plate forwardly extended from a front side of said holder body, and a bearing surface portion defined at a top side of said front tongue plate;
a conducting terminal set comprising 5pcs of conducting terminals mounted in said holder body of said electrical insulating terminal holder, 4pcs of signal terminals mounted in said holder body and extended to said front tongue plate, each said conducting terminal comprising a mating contact end portion located at a front end thereof and suspending in one said elongated opening of said electrically insulating terminal holder and a bonding end portion located at an opposite rear end thereof and extended out of a rear side of said holder body of said electrically insulative terminal holder, each said signal terminal comprising a mating contact end piece located at a front end thereof and supported on the bearing surface portion at the top side of said front tongue plate and a bonding end piece located at an opposite rear end thereof and extended out of a rear side of said holder body of said electrically insulative terminal holder in co-planar relationship to the bonding end portions of said conducting terminals, said conducting terminals being classified as 1^{st} grounding terminal, 1^{st} differential signal terminal, 2^{nd} differential signal terminal, 3^{rd} differential signal terminal and 4^{th} differential signal terminal, said 1^{st} grounding terminal being arranged on the middle, said 1st differential signal terminal and said 4^{th} differential signal terminal being arranged in parallel at two opposite lateral sides relative to said 1^{st} grounding terminal, said 2^{nd} differential signal terminal and said 3^{rd} differential signal terminal being arranged in parallel and respectively spaced between said 1^{st} grounding terminal and said 1^{st} differential signal terminal and between said 1^{st} grounding terminal and 4^{th} differential signal terminal, said signal terminals being classified as 5^{th} differential signal terminal, 6^{th} differential signal terminal, 1^{st} power terminal and 2^{nd} grounding terminal, said 5^{th} differential signal terminal and said 6^{th} differential signal terminal being arranged in parallel between said 1^{st} grounding terminal and said 2^{nd} differential signal terminal and between said 1^{st} grounding terminal and said 3^{rd} differential signal terminal, said 1^{st} power terminal and said 2^{nd} grounding terminal being arranged in parallel at two opposite lateral sides relative to said conducting terminals;
an EMI shielding shell surrounding said electrically insulative terminal holder, said EMI shielding shell comprising an accommodation chamber that accommodates said holder body and a mounting structure that surrounds a part of said front tongue plate; and
a swivel adapter comprising a metal shielding cover pivotally connected to said mounting structure of said EMI shielding shell, an insulative terminal holder mounted in said metal shielding cover and an adapter terminal set mounted in said insulative terminal holder, said adapter terminal set comprising 5pcs of adapter terminals matching with said metal shielding cover and said insulative terminal holder to constitute a micro USB connector, said terminal holder comprising a base portion, a plurality of terminal slots cut through opposing top and bottom sides of said base portion and arranged in parallel and a tongue plate portion forwardly extended from a front side of said base portion, said metal shielding cover comprising a bottom-open receiving chamber adapted for receiving the base portion of said insulative terminal holder, said adapter terminals being mounted in said base portion and said tongue plate portion of said insulative terminal holder, each said adapter terminal comprising a rear abutment portion inserted through and suspending in a bottom side of one respective said terminal slot and an opposite front contact portion positioning in said tongue plate portion, said adapter terminals being classified as 7^{th} differential signal terminal, 8^{th} differential signal terminal, 2^{nd} power terminal, 3^{rd} grounding terminal and supplementary transmission terminal, said 7^{th} differential signal terminal and said 8^{th} differential signal terminal being arranged in parallel on the middle, said 2^{nd} power terminals and said 3^{rd} grounding terminal being arranged in parallel at two opposite lateral sides relative to said 7^{th} differential signal terminal and said 8^{th} differential signal terminal, said supplementary transmission terminal being connected to an inner side of said 3^{rd} grounding terminal.

8. The USB adapter module as claimed in claim 7, wherein the front contact portion of said 2^{nd} power terminals is configured in the shape of an open loop, providing two contact surfaces.

9. The USB adapter module as claimed in claim 7, wherein said supplementary transmission terminal is extended from an inner side of said 3^{rd} grounding terminal and disposed adjacent to said 7^{th} differential signal terminal and configured subject to USB/OTG specifications.

10. The USB adapter module as claimed in claim 7, wherein said adapter terminals of said adapter terminal set each have a rear part thereof curved sideways to form an extension arm that has a distal end forming the rear abutment portion of the respective said adapter terminal; said adapter terminal set further comprises a first supplementary rib and a second supplementary rib respectively outwardly extended from the extension arms of said 3^{rd} grounding terminal and said 2^{nd} power terminals, said first supplementary rib and said second supplementary rib each having a protruded retaining portion extended out of said metal shielding cover.

11. The USB adapter module as claimed in claim 7, wherein said metal shielding cover of said further comprises a front extension casing located at a front side relative to said bottom-open receiving chamber, and a sub receiving chamber defined in said front extension casing in communication with said bottom-open receiving chamber and configured subject to micro USB specifications for receiving said tongue plate portion of said insulative terminal holder and said adapter terminals.

12. A USB adapter module, comprising:
an electrical insulating terminal holder comprising a holder body, a plurality of elongated openings cut through opposing top and bottom walls of said holder body, a front tongue plate forwardly extended from a front side of said holder body, and a bearing surface portion defined at a top side of said front tongue plate;
a conducting terminal set comprising a plurality of conducting terminals mounted in said holder body of said electrical insulating terminal holder, a plurality of signal terminals mounted in said holder body and extended to said front tongue plate, each said conducting terminal comprising a mating contact end portion located at a front end thereof and suspending in one said elongated opening of said electrically insulating terminal holder and a bonding end portion located at an opposite rear end thereof and extended out of a rear side of said holder body of said electrically insulative terminal holder, each said signal terminal comprising a mating contact end piece located at a front end thereof and supported on the bearing surface portion at the top side of said front tongue plate and a bonding end piece located at an opposite rear end thereof and extended out of a rear side of said holder body of said electrically insulative terminal holder in co-planar relationship to the bonding end portions of said conducting terminals;
an EMI shielding shell surrounding said electrically insulative terminal holder, said EMI shielding shell comprising an accommodation chamber that accommodates said holder body and a mounting structure that surrounds a part of said front tongue plate;
a swivel adapter comprising a metal shielding cover pivotally connected to said mounting structure of said EMI shielding shell, an insulative terminal holder mounted in said metal shielding cover and a set of adapter terminals mounted in said insulative terminal holder, said insulative terminal holder comprising a base portion, a plurality of terminal slots cut through opposing top and bottom sides of said base portion and arranged in parallel and a tongue plate portion forwardly extended from a front side of said base portion, said metal shielding cover comprising a bottom-open receiving chamber adapted for receiving the base portion of said insulative terminal holder, a front extension casing located at a front side relative to said bottom-open receiving chamber, a sub receiving chamber defined in said front extension casing in communication with said bottom-open receiving chamber and adapted for receiving said tongue plate portion of said insulative terminal holder and said adapter terminals and two longitudinal slots cut through a top wall of said front extension casing in communication with said sub receiving chamber, said adapter terminals being mounted in said base portion and said tongue plate portion of said insulative terminal holder, each said adapter terminal comprising a rear abutment portion inserted through and suspending in a bottom side of one respective said terminal slot and an opposite front contact portion positioning in said tongue plate portion; and
a pivot connection structure to pivotally couple said metal shielding cover of said swivel adapter and said mounting structure of said EMI shielding shell together, said pivot connection structure comprising two pivot rods bilaterally located at one of said metal shielding cover and said mounting structure, at least one retaining hole located at one of said metal shielding cover and said mounting structure, two pivot holes bilaterally located at the other one of said metal shielding cover and said mounting structure and respectively pivotally coupled to said pivot rods, and at least one retaining rod located at the other one of said metal shielding cover and said mounting structure and detachably engageable with said at least one retaining hole.

13. The USB adapter module as claimed in claim 12, wherein said pivot rods are bilaterally located at said metal shielding cover; said pivot holes are bilaterally located at said mounting structure and respectively pivotally coupled to said pivot rods.

14. The USB adapter module as claimed in claim 12, wherein said pivot holes are bilaterally located at said metal shielding cover; said pivot rods are bilaterally located at said mounting structure and respectively pivotally coupled to said pivot rods.

15. The USB adapter module as claimed in claim 12, wherein said pivot connection structure comprises two said retaining holes bilaterally located at said metal shielding cover, and two said retaining rods bilaterally located at said mounting structure and respectively detachably engageable with said two retaining holes.

16. The USB adapter module as claimed in claim 12, wherein said pivot connection structure comprises two said retaining rods bilaterally located at said metal shielding cover, and two said retaining holes bilaterally located at said mounting structure and respectively detachably engageable with said two retaining rods.
